(19) United States
(12) Patent Application Publication
(10) Pub. No.: US 2007/0123293 A1
(43) Pub. Date: May 31, 2007

(54) METHOD AND DEVICE(S) ENCODING SPEECH DATA IN RADIO ACCESS NETWORK OF RADIO COMMUNICATION SYSTEM

(75) Inventors: Jorg BRENNER, Hamburg (DE); Ricklef Dembski-Minssen, Sittensen (DE); Dirk Schwenke, Hamburg (DE); Florian Wolff, Hamburg (DE); Stefan von der Heide, Norderstedt (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 11/557,768

(22) Filed: Nov. 8, 2006

(30) Foreign Application Priority Data
Nov. 8, 2005 (EP) 05024343

(51) Int. Cl. H04B 7/00

(52) U.S. Cl. 455/525

(57) ABSTRACT

A device receives from a base station speech data encoded with a first speech codec, transcodes the speech data into a second speech codec and transmits the speech data encoded with the second speech codec toward a base station controller used for controlling the transmission of the speech data.

### CROSS REFERENCE TO RELATED APPLICATIONS

This application is based on and hereby claims priority to European Application No. EP05024343 filed on Nov. 8, 2005, the contents of which are hereby incorporated by reference.

### BACKGROUND

The method described below relates to operating devices for encoding speech data in a radio access network of a radio communication system.

In radio access networks of radio communication systems base stations are used for transmitting and receiving data, for example speech data, to and from mobile stations. To control data transmission to and from the mobile stations each base station is connected to a base station controller. For the transmission of speech data the speech data is encoded with a speech codec and is transmitted in encoded form over a wireless interface between mobile stations and base stations.

When a connection is set up signaling data is exchanged between a mobile station and a base station provided to supply radio coverage to the mobile station as well as with the corresponding base station controller. The signaling data serves for example to define a speech codec which will subsequently be used for speech transmissions. Speech data sent by a mobile station is encoded in the mobile station with the speech codec, sent to the base station, and from there forwarded to the corresponding base station controller. Transcoding of the speech data which is needed for forwarding the speech data to a core network connected to the base station controller is undertaken in the base station controller into another speech codec. In the opposite direction of transmission, i.e. for speech data transmitted from the core network to the mobile station, the received speech codec is transcoded in a transcoding unit in the base station controller into that speech codec which was previously defined with the mobile station.

When a speech codec for speech data transmission with the mobile station is defined account is taken of the speech codecs that the mobile station supports. Only those speech codecs are used which are supported by the mobile station. In such cases those speech codecs supported by the mobile station are normally selected which allow the bandwidth of the wireless interface to be utilized as efficiently as possible.

Upwards-compatibility is an important characteristic in the further development of a radio standard of a radio communication system. This means that even mobile stations which conform to a first older version of the radio standard must be capable of functioning in a second newer version. This can for example mean that the radio communication system with a new version of the radio standard supports a speech codec which is not supported by base stations in accordance with an older version. The fact that the speech codec to be selected for speech transmission is the codec which is also supported by a mobile station means that a network operator of a radio communication system is restricted in their flexibility of choice of the speech codec used and can thus sometimes not take into account, when defining a speech codec to be used, of the bandwidth which is available for example for transmissions from base stations to the base station controllers.

A radio communication system is known from U.S. Pat. No. 5,999,813 A in which a Transcoder-Rate Adapter Unit (TRAU) is used for rate conversion or rate adaptation in a base station (BTS) and is optionally arranged in a base station controller (BSC).

### SUMMARY

An aspect is to specify methods as well as corresponding devices by which a greater flexibility in the use of a speech codec within a radio access network of a radio communications system can be obtained.

In the method described below for operating a device for encoding speech data in a radio access network of a radio communications system, the device receives from a base station data encoded with a first speech codec, transcodes the coded speech data into a second speech codec, and transfers the data transcoded with the second speech codec to a base station controller used for controlling the transmission of the speech data. The device receives signaling data which is transmitted in the radio communication system between the base station controller and a mobile station connected to a base station over a wireless interface and/or between the base station controller and the base station, and is used to define the first speech codec for speech data of the mobile station, and modifies the signaling data such that the signaling data signals the first speech codec to the mobile station and the second speech codec to the base station controller.

In this way base stations and base station controllers which are already provided for operation in a radio communication system without a device as described below and which thus exchange the speech data without the device directly with one another in the speech codec which was defined in a connection setup with the corresponding mobile station are used for the method without having to be modified. The device thus assumes the functionality of a base station controller in relation to the mobile station and the functionality of a mobile station in relation to a base station controller.

In an alternative method for operating a device for encoding speech data in a radio access network of a radio communication system, the device receives from a base station speech data encoded with a first speech codec, transcodes the coded speech data into a second speech codec and transmits the speech data encoded with the second speech codec to a base station controller used for controlling the transmission of the speech data. Accordingly, there is provision for speech data transmitted from the device with the second speech codec to the base station controller to first be received by a further device, transcoded into the first speech codec and only then forwarded to the base station controller.

This is a way of avoiding the device having to modify signaling data which is used to define a speech codec, as previously described. A speech codec is defined during a connection setup as already described in the introduction to this description and base station controller and mobile station define the first speech codec for example. The device transcodes speech data of the first speech codec into the second speech codec, transmits the encoded speech data to a further device, and in this device the speech data is again transcoded back into the first speech codec so that the transcoding in the second speech codec is transparent both for the mobile station and also for the base station controller. This duplicated transcoding can thus also be advantageously used if for example another speech codec is of greater advantage for utilizing a satellite transmission to transmit data between a base station controller and a base station than the speech codec which the mobile station supports or which is advantageous for the available bandwidth of the radio transmission with the base station. However this embodiment requires an additional transcoding compared to the embodiment without the further device, which causes a further delay in the transmission of the speech data so that the first-mentioned embodiment would be preferable. The embodiment without a further device is also the preferred embodiment for commercial reasons because of the small outlay required for implementation.

It is thus possible for speech data which the base station receives from a mobile station over a wireless interface with a first speech codec which is supported by the mobile station to be transcoded by the device into a second speech codec, which for example is not supported by the mobile station, and then to be transmitted with this second speech codec from the device to the base station controller used for controlling the transmission of the speech data between the base station and the mobile station. In this way for example a speech codec can be used as a second speech codec which is adapted to the bandwidth available for a connection between the base station and the base station controller. For example the bandwidth can be lower on a connection between base station and base station controller than the bandwidth on the wireless interface between the mobile station and the base station. A speech codec with a lower data rate than the second speech codec can then be used even if the mobile station does not support the second speech codec itself.

In an embodiment there is a further transcoding of the speech data for example with a third speech codec in the base station controller. From there the speech data is forwarded with the third speech codec, e.g. with Pulse Code Modulation (PCM), to devices of a core network in order to be forwarded from there to a station which is provided for the receipt of speech data.

A preferred embodiment makes provision for the speech data encoded with the second speech codec to be transmitted at least partly over a wireless interface to the base station controller.

For example, in radio communication systems in which base stations are arranged in aircraft, the speech data which the base stations in the aircraft receive from the mobile stations operated there is forwarded over a satellite link to a base station controller of the terrestrial part of the radio access network of the radio communication system. In the opposite direction too the satellite link is used for forwarding speech data to the mobile stations in the aircraft. This type of link using satellites has a comparatively small bandwidth of for example 64 kbit/s, which a number (e.g. seven) of mobile stations with their signaling and speech data as well as data services must divide up, so that speech codec other than the speech codec which the mobile stations in the aircraft use to communicate with at least one base station arranged on the aircraft can be used on this transmission link.

For example the mobile stations in a radio communication system in accordance with the Global System for Mobile Communications (GSM) standard use GSM Full Rate with 13 kbit/s as a speech codec. This speech codec is then transcoded by a device, which is arranged for example in the radio station in the aircraft, into the second speech codec, for example in Adaptive Multirate (AMR) at 4.75 kbit/s. The speech data can then be sent with the second speech codec over the satellite link to the base station controller on the ground. The speech data is then a transcoded into PCM for example in the base station controller and supplied to a connected core network for further transmission.

The device can be operated as a separate unit which is linked for example via an electrical or optical line to a conventional base station and is for example also arranged in the aircraft. Of course as an alternative the device can also be integrated into a newly-constructed base station.

### BRIEF DESCRIPTION OF THE DRAWINGS

These and other aspects and advantages will become more apparent and more readily appreciated from the following description of the preferred embodiments, taken in conjunction with the accompanying drawings of which:

FIG. 1 is block diagram of a first preferred embodiment using a transcoding device disposed between a base station and an associated base station controller, and

FIG. 2 is block diagram of a further embodiment using a further device which is arranged between the device and the base station controller to execute further transcoding.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

A mobile station is for example a mobile radio terminal, especially a mobile telephone or a mobile or static device for transmission of picture and/or sound data for fax, Short Message Service SMS, Multimedia Messaging Service MMS and/or e-mail dispatch and/or for Internet access.

A base station is for example a base station of a radio communication system which receives payload and/or signaling data from the mobile station and sends payload and/or signaling data to the mobile station. A base station is connected via network-side devices to a core network via which connections are made to other radio communication systems or into other data networks. A data network is for example taken to mean the Internet or a fixed network with for example circuit switched or packet switched connections for speech and/or data. A network-side device is for example a base station controller which is used for controlling radio transmissions between the base station and mobile stations. The connection between the base station and a base station controller can be made both via a wireless interface, for example a satellite connection, or hard wired via for example an electrical or optical connection.

The method can be used advantageously in any radio communication system. Radio communication systems are taken to mean systems in which a data transmission between base stations takes place over a wireless interface. Data transmission can be both bidirectional and also unidirectional. Radio communication systems are especially any mobile radio system for example in accordance with the GSM or the Universal Mobile Telecommunications System (UMTS) standard. Future mobile radio communication systems, for example of the fourth generation, as well as ad-hoc-networks, are also to be understood as radio communication systems. Radio communication systems are for example also Wireless Local Area Networks (WLANs) in accordance with the Institute of Electrical and Electronics Engineers (IEEE) 802.11a-i, HiperLAN1 and HiperLAN2 standards, where HiperLAN stands for High performance radio local area network, as well as Bluetooth networks and broadband networks with wireless access, for example in accordance with IEEE 802.16.

The method can advantageously be used if a base station is arranged in an aircraft and is linked via a satellite connection to a terrestrial base station controller.

The method is described below using a mobile radio system in accordance with the GSM standard as an example, without however wishing to express that the implementation is restricted to this.

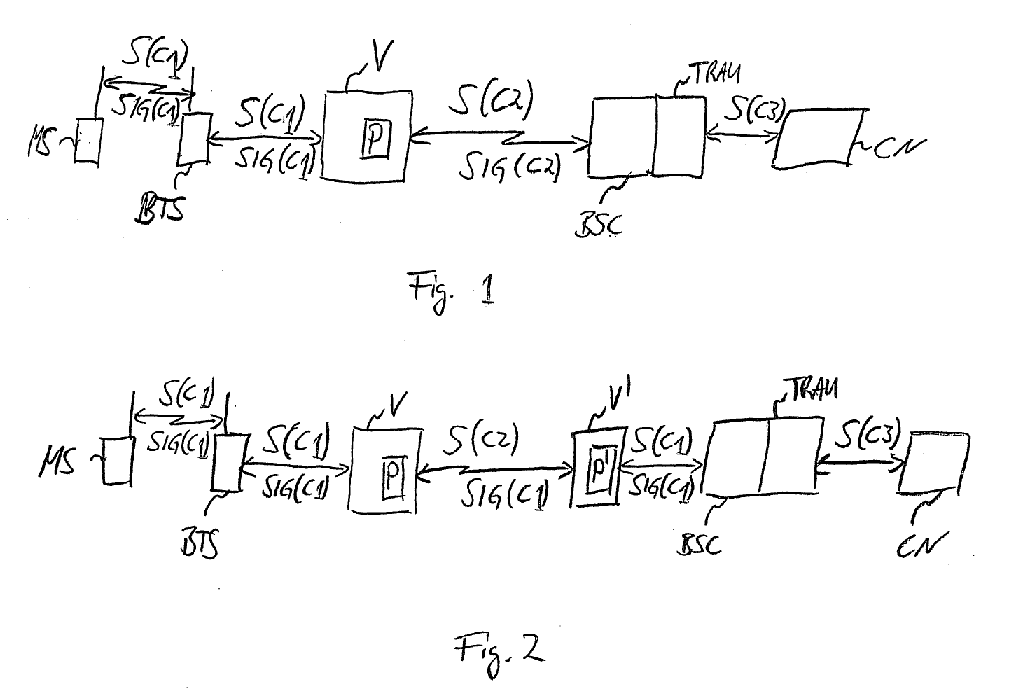

FIG. 1 shows a schematic diagram of a mobile station MS, which sends signaling data SIG over a wireless interface to a base station BTS in order to set up a radio connection to the base station BTS. The signaling data, as well as further data needed to set up a radio connection for example In accordance with the GSM standard, also contains information which shows the radio communication system that the user station supports a first speech codec C1 and wishes to transmit and to receive speech data encoded with this speech codec. The base station BTS transmits the signaling data SIG via a device V connected for example by an electrical or an optical line to the radio station BTS to a base station controller BSC.

The mobile station MS is for example a mobile telephone operating in the aircraft. The base station BTS as well as the device V are in this case likewise arranged in the aircraft.

In the exemplary embodiment for FIG. 1 data is exchanged between the device V and the base station controller BSC over a wireless interface, for example a satellite link. For transmission over the wireless interface between the device V and the base station controller BSC, transmission with a second speech codec C2 is better than transmission with the first speech codec C1 for the bandwidth available there. The device V thus forwards the signaling data SIG over the wireless interface to the base station controller BSC, but signals that the second speech codec C2 is the speech codec required by the mobile station. By further signaling, data not shown in the diagram for reasons of clarity a radio connection is set up for the mobile station MS and the use of the first codec C1 is defined. The device V in this case ensures through the modified signaling data SIG that the base station controller BSC uses as its starting point for the transmission the fact that the use of the second speech codec C2 was defined for the transmission, while the device simultaneously signals to the mobile station that the use of the first speech codec C1 was defined.

The base station BS thus receives speech data S with the first speech codec C1 from the mobile station MS and forwards this speech data S to the device V. In the device V the speech data S is transcoded into the second speech codec C2 and for example transmitted over the satellite link to the base station controller BSC. In the base station controller BSC or connected to the latter is a transcoding unit TRAU, which transcodes speech data received with the second speech codec C2 into a third speech codec C3 and forwards it with the third speech codec C3 to a core network which is connected to the base station controller BSC. From there for example the speech data S is forwarded to a station not shown in the diagram which communicates with the mobile station MS. In the same way speech data which is intended for receipt by the mobile station is sent by the base station controller BSC with the second speech codec C2 to the device V, transcoded there into the first speech codec C1, forwarded to the base station BTS and sent from there over the wireless interface with the first speech codec C1 to the mobile station MS.

Of course the method can also be advantageously used if all the components involved are arranged on the ground and/or if a wired connection exists between the device and the base station controller.

In an alternative exemplary embodiment in FIG. 2 a schematic diagram shows the same stations and devices as are shown in FIG. 1. The speech data S is transmitted in the same way between the mobile station MS and the device V as was previously described with reference to FIG. 1. In addition a further device V′ is arranged between the device V and the base station controller BSC. The further device V′ serves to transcode into the first speech codec C1 speech data which the further device V′ receives from the device V with the second speech codec C2, and to forward it to the base station controller BSC. Likewise speech data which is intended for the mobile station MS is sent from the base station controller BSC with the first speech codec C1 to the further device V′, is transcoded there into the second speech codec C2 and transmitted to the device V. The transmission between the device V and the further device V′ is in this case also a transmission over a wireless interface, for example over the broadband-limited satellite link which is depicted in FIG. 1 for use between the device V and the base station controller.

Thus, when a connection is set up, in the way described with reference to FIG. 1, signaling of the mobile station MS is undertaken by signaling data SIG to indicate that it would like to use the first speech codec C1. The signaling data SIG is forwarded without being modified via the device V and the further device V′ to the base station controller BSC, and it is determined between the base station controller and the mobile station MS that both are using the first speech codec C1 for sending speech data. This means that the device V and also the further device V′ do not have to modify any signaling data but they convert the first speech codec C1 transparently for the mobile station MS and the base station controller BSC into the second speech codec C2.

The transmission of the speech data S in accordance with the alternate exemplary embodiment depicted in FIG. 2 thus differs from the exemplary embodiment depicted in FIG. 1 merely by the addition of the further device V′, which undertakes an additional transcoding of the second speech codec C2 into the first speech codec C1 and vice versa between the device V and the base station controller BSC. In the base station controller BSC the speech data S is transcoded from the first speech codec C1 into the third speech codec C3 and forwarded to the core network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method of operating a device for encoding speech data in a radio access network of a radio communication system, comprising:
receiving, from a base station, speech data encoded with a first speech codec
transcoding the speech data into a second speech codec;
sending the speech data encoded with the second speech codec to a base station controller used to control transmission of the speech data;
receiving, at the device, first signaling data used to define the first speech codec for speech data of a mobile station and transmitted in the radio communication system between the base station controller and the mobile station connected to the base station over a wireless interface and/or transmitted between the base station controller and the base station;
using the first signaling data for the first speech codec in communication with the mobile station;
modifying the first signaling data to produce second signaling data for the second speech codec; and
using the second signaling data for the second speech codec in communication with the base station controller.

2. A method as claimed in claim 1, wherein the base station controller further transcodes the speech data.

3. A method as claimed in claim 2, wherein said sending transmits at least part of the speech data encoded with the second speech codec over a wireless interface to the base station controller.

4. A method as claimed in claim 1, wherein said sending transmits at least part of the speech data encoded with the second speech codec over a wireless interface to the base station controller.

5. A method of operating devices for encoding speech data in a radio access network of a radio communication system, comprising:
receiving, from a base station at a first device, speech data encoded with a first speech codec;
transcoding, at the first device, the speech data into a second speech codec;
sending the speech data encoded with the second speech codec from the first device toward a base station controller used to control transmission of the speech data;
receiving, at a second device prior to receipt by the base station controller, the speech data encoded with the second speech codec;
transcoding, at the second device, the speech data into the first speech codec; and
after said transcoding by the second device, forwarding to the base station controller the speech data encoded with the first speech codec.

6. A method as claimed in claim 5, wherein the base station controller further transcodes the speech data.

7. A method as claimed in claim 6, wherein said sending transmits at least part of the speech data encoded with the second speech codec over a wireless interface toward the base station controller.

8. A method as claimed in claim 5, wherein said sending transmits at least part of the speech data encoded with the second speech codec over a wireless interface toward the base station controller.

9. A device for encoding speech data in a radio access network of a radio communication system having a base station, a base station controller and a mobile station, comprising:
means for receiving, from the base station, speech data encoded with a first speech codec;
means for transcoding the speech data into a second speech codec;
means for sending the speech data encoded with the second speech codec to the base station controller used to control transmission of the speech data;
means for receiving first signaling data used to define the first speech codec for speech data of the mobile station and transmitted in the radio communication system between the base station controller and the mobile station connected to the base station over a wireless interface and/or transmitted between the base station controller and the base station;
means for using the first signaling data for the first speech codec in communication with the mobile station;
means for modifying the first signaling data to produce second signaling data for the second speech codec; and
means for using the second signaling data for the second speech codec in communication with the base station controller.

10. A system for encoding speech data in a radio access network of a radio communication system having a base station, a base station controller and a mobile station, comprising:
a first device receiving from the base station speech data encoded with a first speech codec, transcoding the speech data into a second speech codec and sending the speech data encoded with the second speech codec toward the base station controller used to control transmission of the speech data; and
a second device receiving, prior to receipt by the base station controller, the speech data encoded with the second speech codec, transcoding the speech data into the first speech codec and forwarding to the base station controller the speech data encoded with the first speech codec.
